(19) United States
(12) Patent Application Publication
(10) Pub. No.: US 2026/0136337 A1
(43) Pub. Date: May 14, 2026

(54) METHOD FOR RESOURCE SELECTION, AND TERMINAL DEVICE THEREOF

(71) Applicant: GUANGDONG OPPO MOBILE TELECOMMUNICATIONS CORP., LTD., Dongguan (CN)

(72) Inventors: Yi DING, Dongguan (CN); Zhenshan ZHAO, Dongguan (CN)

(21) Appl. No.: 19/445,461

(22) Filed: Jan. 9, 2026

Related U.S. Application Data
(63) Continuation of application No. PCT/CN2023/112654, filed on Aug. 11, 2023.

(51) Int. Cl. H04W 72/0446; H04L 5/00; H04W 72/25

(52) U.S. Cl. CPC H04W 72/0446; H04L 5/0098; H04W 72/25

(57) ABSTRACT

Provided is a method for resource selection. The method is performed by a terminal device. The method includes: for N second time-domain units corresponding to a first time-domain unit, performing resource selection based on the N second time-domain units; wherein the first time-domain unit and each of the N second time-domain units correspond to different carriers, and N is an integer greater than 1.

### CROSS-REFERENCE TO RELATED APPLICATION

This application is a continuation of International Application No. PCT/CN2023/112654, filed Aug. 11, 2023, the entire disclosure of which is incorporated herein by reference.

### TECHNICAL FIELD

Embodiments of the present disclosure relate to the field of communication technologies, and in particular, relate to a method for resource selection, and a terminal device thereof.

### RELATED ART

In sidelink (SL) communications, a terminal device selects transmission resources via sensing in a resource pool. With evolution of technologies, further research is still required on how the terminal device performs resource selection in a carrier aggregation SL scenario.

### SUMMARY

Embodiments of the present disclosure provide a method for resource selection, and a terminal device thereof. The technical solutions are as follows:

In some embodiments of the present disclosure, a method for resource selection is provided. The method is performed by a terminal device, and includes: for N second time-domain units corresponding to a first time-domain unit, performing resource selection based on the N second time-domain units; wherein the first time-domain unit and each of the N second time-domain units correspond to different carriers, and N is an integer greater than 1.

In some embodiments of the present disclosure, a terminal device is provided. The terminal device includes: a processor and a memory configured to store one or more computer programs. The processor is configured to load and run the one or more computer programs to cause the terminal device to: for N second time-domain units corresponding to a first time-domain unit, perform resource selection based on the N second time-domain units; wherein the first time-domain unit and each of the N second time-domain units correspond to different carriers, and N is an integer greater than 1.

### BRIEF DESCRIPTION OF DRAWINGS

FIG. 1 is a schematic diagram of a network architecture according to some embodiments of the present disclosure;

FIG. 2 is a schematic diagram of an SL communication according to some embodiments of the present disclosure;

FIG. 3 is a schematic diagram of a physical layer structure of a new radio (NR) SL system according to some embodiments of the present disclosure;

FIG. 4 is a schematic diagram of time-frequency resource positions reservation according to some embodiments of the present disclosure;

FIG. 5 is a schematic diagram of resource sensing and resource selection according to some embodiments of the present disclosure;

FIG. 6 is a schematic diagram of long term evolution (LTM) SL and NR SL carrier aggregation according to some embodiments of the present disclosure;

FIG. 7 is a schematic diagram of carrier aggregation according to some embodiments of the present disclosure;

FIG. 8 is a schematic diagram of in-band emission according to some embodiments of the present disclosure;

FIG. 9 is a schematic diagram of NR SL carrier aggregation according to some embodiments of the present disclosure;

FIG. 10 is a flowchart of a method for resource selection according to some embodiments of the present disclosure;

FIG. 11 is a schematic diagram of receive power of data transmitted in a first time-domain unit according to some embodiments of the present disclosure;

FIG. 12 is a schematic diagram of a method for resource selection according to some embodiments of the present disclosure;

FIG. 13 is a schematic diagram of a method for resource selection according to some embodiments of the present disclosure;

FIG. 14 is a block diagram of an apparatus for resource selection according to some embodiments of the present disclosure; and

FIG. 15 is a schematic structural diagram of a terminal device according to some embodiments of the present disclosure.

### DETAILED DESCRIPTION

For clearer descriptions of the objectives, technical solutions, and advantages of the present disclosure, embodiments of the present disclosure are further described in detail herein after with reference to the accompanying drawings.

A network architecture and a service scenario described in the embodiments of the present disclosure are intended to describe the technical solutions according to the embodiments of the present disclosure more clearly, but do not constitute any limitation on the technical solutions according to the embodiments of the present disclosure. Those of ordinary skilled in the art may understand that, with evolution of the network architecture and the emergence of new service scenarios, the technical solutions according to the embodiments of the present disclosure are also applicable to similar technical problems.

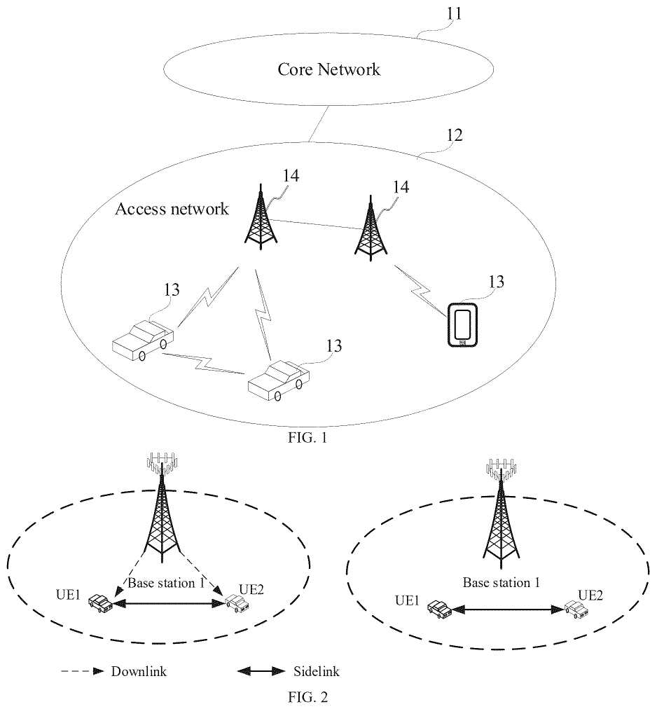

FIG. 1 illustrates a schematic diagram of a network architecture according to some embodiments of the present disclosure. The network architecture may involve: a core network 11, an access network 12, and terminal devices 13.

The core network 11 includes a plurality of core network devices. The functions of core network devices primarily involve providing user connectivity, managing users, and carrying out service completion, serving as an interface to external networks as a transport network. For example, the core network of a 5^{th} generation mobile communication (5G) new radio (NR) system includes devices such as an access and mobility management function (AMF) entity, a user plane function (UPF) entity, and a session management function (SMF) entity.

The access network 12 includes a plurality of access network devices 14. The access network in the 5G NR system may be referred to as a new generation-radio access network (NG-RAN). The access network devices 14 refer to apparatuses deployed in the access network 12 to provide wireless communication functionalities for the terminal devices 13. The access network device 14 includes various forms of macro base stations, micro base stations, relay stations, access points, and the like. The name of the device with functionality of an access network device varies in different systems employing different radio access technologies. For example, the device is referred to as a gNodeB or a gNB in the 5G NR system. The name “access network device” may vary with the evolution of communication technologies. For convenience of description, the above apparatuses providing the wireless communication functionalities for the terminal devices 13 are collectively referred to as the access network device in the embodiments of the present disclosure.

Typically, a plurality of terminal devices 13 are provided, and one or more terminal devices 13 may be distributed within the cell managed by each of the access network devices 14. The terminal devices 13 may include various handheld devices, in-vehicle devices, wearable devices, computing devices, other processing devices connected to a radio modem with the wireless communication functionality, various forms of user equipments (UEs), mobile stations (MS), and the like. For convenience of description, the devices described above are collectively referred to as the terminal devices. The access network devices 14 communicate with the core network devices using an air interface technology, such as an NG interface in the 5G NR system. The access network devices 14 communicate with the terminal devices 13 using an air interface technology, such as a Uu interface. The “terminal device” in the embodiments of the present disclosure is also referred to as the UE or the terminal, which both have the same meaning.

The terminal devices 13 (for example, the in-vehicle device and another device, such as another in-vehicle device, a mobile phone, or a road side unit (RSU)) may communicate with each other over a direct communication interface (for example, a prose communication 5 (PC5 ) interface). Accordingly, the communication link established based on the direct communication interface may be referred to as a direct link or an SL. The SL transmission means that data transmission is directly carried out between the terminal devices over an SL, which is different from a conventional cellular system in which the communication data is received or transmitted by the access network device. The SL transmission has characteristics of short delay and low overhead, and is therefore suitable for communication between two terminal devices that are geographically close to each other (such as an in-vehicle device and another peripheral device that is geographically close to the in-vehicle device). It should be noted that, in FIG. 1, only vehicle-to-vehicle communication in a vehicle-to-everything (V2X) scenario is illustrated, while the SL communication is applicable to various scenarios where terminal devices directly communicate with each other. In other words, the terminal device in the present disclosure refers to any device that communicates with another device over the SL.

The “5G NR system” in the embodiments of the present disclosure may also be referred to as a 5G system or an NR system, but those skilled in the art may understand the meaning thereof. The technical solutions according to the embodiments of the present disclosure are applicable to the 5G NR system, and also to future evolved systems of the 5G NR system.

Before description of the technical solutions of the present disclosure, some related technical knowledge involved in the present disclosure is first explained. The following related technologies may be combined with the technical solutions according to the embodiments of the present disclosure in any manner, all of which fall within the scope of protection of the embodiments of the present disclosure. The embodiments of the present disclosure include at least some of the following content.

### 1. SL Transmission

Regarding the SL transmission, the third Generation Partnership Project (3GPP) has defined two transmission modes: a mode A and a mode B.

In the mode A, as illustrated in the diagram on the left side in FIG. 2, transmission resources of the terminal device are assigned by an access network device (e.g., a base station). The terminal device transmits communication data over the sidelink based on the transmission resources assigned by the access network device. The access network device may assign transmission resources to the terminal device for single transmission, or assign transmission resources to the terminal device for semi-static transmission.

In the mode B, as illustrated in the diagram on the right side in FIG. 2, the terminal device autonomously selects transmission resources from a resource pool for the transmission of communication data. Specifically, the terminal device may select transmission resources from the resource pool either via sensing or via random selection.

Next, SL communication in NR V2X systems where the terminal device autonomously selects resources (i.e., the mode B described above) is mainly described.

### 2. NR V2X Physical Layer Structure

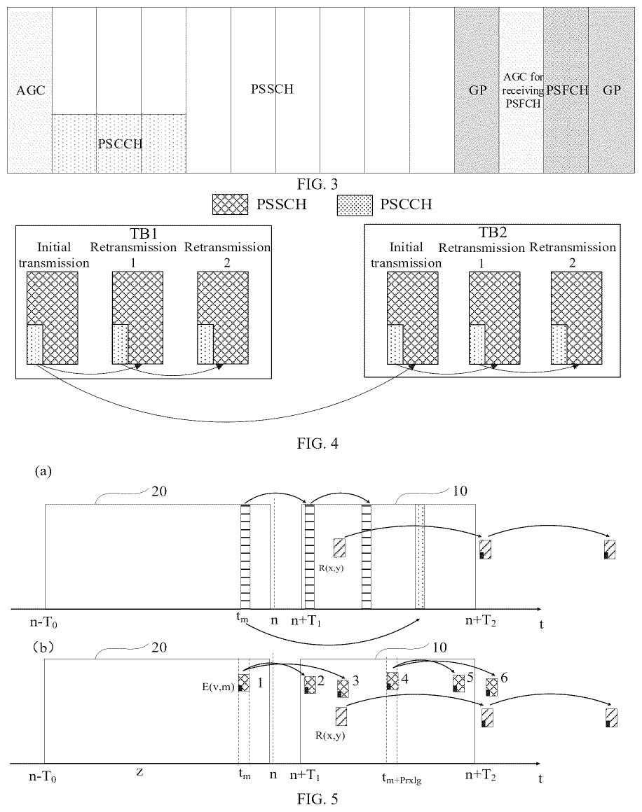

For example, a physical layer structure of an NR SL system is illustrated in FIG. 3. The first symbol in the slot illustrated in FIG. 3 is an AGC symbol. In a case where an SL UE receives data, received AGC gain and radio frequency (RF) parameters for performing reception are adjusted based on a receive power within the symbol. This adjustment optimizes the gain and parameters for demodulation, thereby enabling the demodulation of information in subsequent symbols. In a case where the SL UE transmits data, content of a symbol following the AGC symbol is repeatedly transmitted on the AGC symbol. In FIG. 3, a physical sidelink control channel (PSCCH) is configured to bear first-stage sidelink control information (i.e., first sidelink control information), and the first sidelink control information mainly includes fields related to resource sensing. A physical sidelink shared channel (PSSCH) is configured to bear data and second-stage sidelink control information (i.e., second sidelink control information), wherein the second sidelink control information mainly includes fields related to data demodulation. A slot may include a symbol corresponding to a physical sidelink feedback channel (PSFCH). The PSFCH is configured to transmit hybrid automatic repeat request (HARQ) feedback information. Depending on configuration of the resource pool, the symbol corresponding to the PSFCH occurs once every one, two, and four slots. In a case where a slot does not include the symbol corresponding to the PSFCH, for example, a guard period (GP) symbol between the PSSCH and the PSFCH, the AGC for receiving the PSFCH and a PSFCH symbol in FIG. 3 are all configured to carry the PSSCH. In general, a last symbol in the slot is the GP symbol, that is, GAP. Alternatively, a symbol following the last symbol carrying the PSSCH, or the PSFCH is the GP symbol. The SL UE performs reception-transmission conversion within the GP symbol, but does not transmit data. In a case where a slot includes a PSFCH resource, a GP symbol is present between the PSSCH and the PSFCH symbols. This is because the UE transmits data on the PSSCH and receives data on the PSFCH, and the GP symbols is required for reception-transmission conversion.

### 3. Resource Reservation in NR V2X

In the NR V2X system, in the mode B, the terminal device autonomously selects transmission resources for data transmission. Resource reservation is a prerequisite for resource selection.

The resource reservation means that the terminal device transmits the first sidelink control information on the PSCCH to reserve resources for future use. The NR V2X system supports both intra-transport block (TB) resource reservation and inter-TB resource reservation.

As illustrated in FIG. 4, the terminal device transmits the first sidelink control information, and indicates N time-frequency resources (including resources for current data transmission) of a current TB by using the Time Resource Assignment and Frequency Resource Assignment fields in the first sidelink control information. N≤Nmax, and Nmax is equal to 2 or 3 in NR V2X. Meanwhile, the N indicated time-frequency resources should be arranged in W slots. W is equal to 32 in NR V2X. For example, in the TB1 illustrated in FIG. 4, the terminal device transmits the first sidelink control information on the PSCCH while transmitting initial transmission data on the PSSCH, and indicates time-frequency resource positions for initial transmission and retransmission 1 (i.e., N=2) using the two fields described above. That is, time-frequency resources for retransmission 1 is reserved. Moreover, initial transmission and retransmission 1 are arranged and carried out across 32 slots in a time domain. Similarly, in the TB1 illustrated in FIG. 4, the terminal device indicates time-frequency resource positions for retransmission 1 and retransmission 2 using the first sidelink control information transmitted on the PSCCH of retransmission 1, and retransmission 1 and retransmission 2 are arranged and carried out across 32 slots in the time domain.

Besides, in transmitting the first sidelink control information, the terminal device performs the inter-TB resource reservation using a Resource Reservation Period field. For example, in FIG. 4, in transmitting the first sidelink control information of initial transmission of TB1, the terminal device indicates time-frequency resource positions for initial transmission and retransmission 1 of TB1 using the Time Resource Assignment and Frequency Resource Assignment fields, which are denoted as {(t₁, f₁), (t₂, f₂)}. t₁ and t₂ represent the time domain positions of initial transmission and retransmission 1 resources of TB1, and f₁ and f₂ represent the corresponding frequency domain positions. In a case where a value of the Resource Reservation Period field in the first sidelink control information is 100 ms, the sidelink control information (SCI) simultaneously indicates the time-frequency resources {(t₁+100, f₁), (t₂+100, f₂)}. The two resources are used for the initial transmission and the retransmission 1 of TB2. Similarly, the first sidelink control information transmitted in retransmission 1 of TB1 also reserves time-frequency resources for retransmission 1 and retransmission 2 of TB2 using the Resource Reservation Period field. In NR V2X, possible values for the Resource Reservation Period field are 0, 1-99, 100, 200, 300, 400, 500, 600, 700, 800, 900, and 1000 ms, offering greater flexibility compared to LTE V2X. However, only e values are configured in each resource pool, and the terminal device determines a possible value to be used based on the used resource pool. The e values in the resource pool configuration are denoted as a resource reservation period set M, and exemplarily, e is less than or equal to 16.

In addition, the inter-TB reservation may be activated or deactivated on a resource pool basis via network configuration or pre-configuration. In a case where the inter-TB reservation is activated, the first sidelink control information includes the Resource Reservation Period field. In a case where the inter-TB reservation is deactivated, the first sidelink control information does not include the Resource Reservation Period field. In a case where the inter-TB reservation is activated, the value of the Resource Reservation Period field used by the terminal device, i.e., the resource reservation period, is generally not changed prior to trigger of resource reselection. The terminal device reserves resources for a next period using the Resource Reservation Period field in the first sidelink control information for transmission of another TB each time the terminal device transmits the first sidelink control information, such that periodic semi-persistent transmission is achieved.

In a case where the terminal device operates in the mode B, the terminal device acquires, by sensing the PSCCHs from other terminal devices, the first sidelink control information transmitted by the other terminal devices to acknowledge the resources reserved by the other terminal devices. In resource selection, the terminal device excludes the resources reserved by the other terminal devices to avoid resource collision.

### 4. Resource Selection Method for NR V2X Sensing

In the NR V2X system, the terminal device needs to select resources autonomously in the mode B.

As illustrated in FIG. 5, the terminal device triggers resource selection or reselection in slot n, or slot n is a slot where a higher layer triggers a physical layer to report a candidate resource set. A resource selection window 10 starts from n+T₁ and ends at n+T₂. 0≤T₁≤T_{proc,1}, and T_{proc,1} represents 3, 5, 9, or 17 slots in a case where the subcarrier spacing is 15, 30, 60, or 120 kHz. T₂ₘᵢₙ≤T₂≤a remaining delay budget of services, and a value set of T₂ₘᵢₙ is {1, 5, 10, 20}*2^{μ} slots. μ=0, 1, 2, or 3, which correspond to the subcarrier spacing being 15, 30, 60, or 120 kHz respectively. The terminal device determines T₂ₘᵢₙ from the value set based on a priority of its own to-be-transmitted data. For example, in a case where the subcarrier spacing is 15 kHz, the terminal device determines T₂ₘᵢₙ from the set {1, 5, 10, 20} based on the priority of its own to-be-transmitted data. In a case where T₂ₘᵢₙ is greater than or equal to the remaining delay budget of service, T₂ is equal to the remaining delay budget of service. The remaining delay budget means a difference between a corresponding time of a delay requirement of the data and a current time. For example, for a packet arriving in slot n, the delay requirement is 50 ms. Assuming that least one slot is 1 ms, then the remaining delay budget is 50 ms in a case where the current time is slot n, and the remaining delay budget is 30 ms in a case where the current time is slot n+20.

The terminal device senses resources from n-T₀ to n-T_{proc,0} (excluding n-T_{proc,0}), and a value of T₀ is 100 or 1100 ms. In a case where the subcarrier spacing is 15, 30, 60, or 120 kHz, T_{proc,0} represents 1, 1, 2, or 4 slots. In some embodiments, the terminal device senses resources in a slot that is within a resource pool used by the terminal device within a resource sensing window. In some embodiments, the terminal device senses the first sidelink control information transmitted by another terminal device in each slot (except for its own transmission slot), and the terminal device uses the results of resource sensing in n-T₀ to n-T_{proc,0} upon trigger of resource selection or reselection in slot n.

In step 1, the terminal device determines candidate resources in the resource selection window as resource set A, and any of the candidate resources in set A is denoted as the resource R(x, y). x and y are configured to indicate a frequency domain position and a time domain position of the resource, respectively. For example, x indicates the starting subchannel in the frequency domain for resource R(x, y), and y indicates the slot in the time domain where resource R(x, y) is located. R(x, y) represents L_subchannel consecutive subchannels starting from subchannel x within time slot t_{y}, wherein L_subchannel is configured by higher layers to the physical layer. An initial number of the resources in set A is denoted as Mₜₒₜₐₗ. (t1, t2, t3, and the like) is denoted as a set of slots belonging to the resource pool. The terminal device excludes resources in resource set A based on an unmonitored slot in the resource sensing window and/or resource sensing results in the resource sensing window.

For resource exclusion based on the unmonitored slot, the terminal device determines whether the resource R(x, y) or a series of periodic resources corresponding to the resource R(x, y) are overlapped with a slot determined based on the unmonitored slot, and excludes the resource R(x, y) from resource set A in a case where these resources are overlapped with each other.

For resource exclusion based on the resource sensing results, the terminal device judges whether resource R(x, y) or a series of periodic resources corresponding to the resource R(x, y) are overlapped with a resource determined based on the sensed first sidelink control information, and whether the sidelink reference signal received power (SL-RSRP) determined based on the sensed first sidelink control information is greater than the SL-RSRP threshold. Excludes the resource R(x, y) from resource set A in a case where these resources are overlapped with each other and fulfill the SL-RSRP condition.

In a case where the number of the remaining resources in resource set A upon the resource exclusion is less than Mₜₒₜₐₗ*X, the SL-RSRP threshold is raised by 3 dB, resource set A is initialized, and step 1 is performed again until the number of the remaining resources in resource set A upon the resource exclusion is greater than or equal to Mₜₒₜₐₗ*X. The physical layer reports resource set A upon resource exclusion to a higher layer as a candidate resource set. X is configured by the higher layer of the terminal device to the physical layer.

In step 2, the higher layer randomly selects resources from the reported candidate resource set for data transmission. That is, the terminal device randomly selects resources from the candidate resource set for data transmission.

It should be noted that:

The above description is for the SL communication method in NR-V2X. That is, the terminal device independently selects transmission resources via resource sensing and independently performs data transmission on the SL. The SL communication method is applicable to various SL communications such as direct communication between handheld terminals and direct communication between pedestrians and vehicles.

### 5. AGC Issue Under Different Subcarrier Spacing Conditions

The coexistence of LTE SL and NR SL on a same carrier is discussed in SL. One subframe of LTE SL corresponds to two slots of NR SL in a case where LTE SL uses a 15 kHz subcarrier spacing and NR SL uses a 30 kHz subcarrier spacing. There is an AGC issue in a case where the subcarrier spacings (SCS) is different. That is, the transmission of NR SL has a negative impact on the reception of LTE SL.

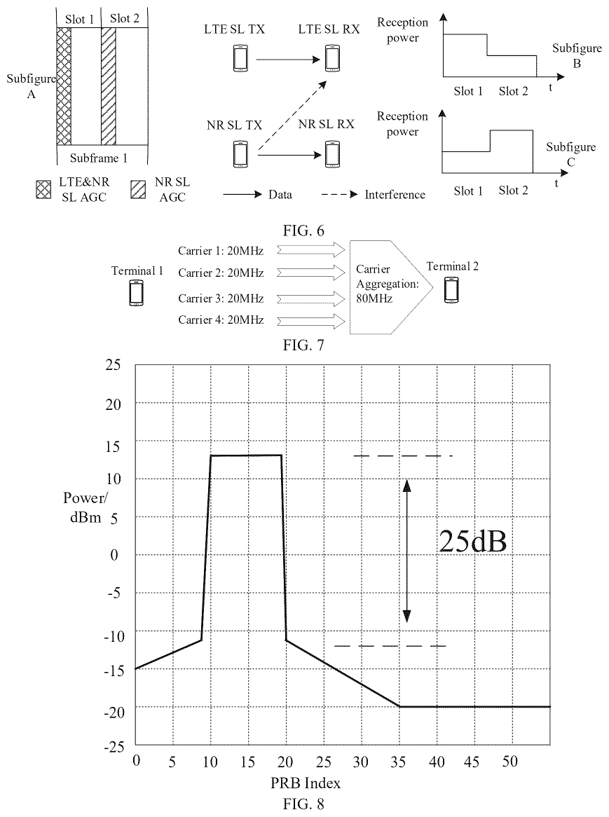

For example, as illustrated in FIG. 6, any subframe 1 of LTE SL corresponds to slot 1 and slot 2 of NR SL. Based on the physical layer structure of LTE SL and NR SL, an LTE SL UE only performs AGC at the beginning of subframe 1, while an NR SL UE performs AGC at the beginning of slot 1 and slot 2. As described above, the function of the AGC symbol includes: in a case where an SL UE receives data, the received AGC gain and RF parameters for performing receiving are adjusted based on a receive power within the symbol. This adjustment optimizes the gain and parameters for demodulation, thereby enabling the demodulation of information in subsequent symbols. In a case where the SL UE transmits data, the SL UE repeatedly transmits the content of the symbol following the AGC symbol on the AGC symbol itself.

Therefore, a negative impact may be exerted on the reception of LTE SL in a case where transmission of NR SL occurs only in one slot, or in a case where the transmit power differs between the two slots in which transmission of NR SL occurs. Specifically, in a case where an LTE SL transmitter (LTE SL TX) transmits data to an LTE SL receiver (LTE SL RX) in subframe 1, and an NR SL TX transmits data to an NR SL RX in slot 1, due to overlapping of time-frequency resources, the LTE SL RX may initially receive power from both the LTE SL TX and the NR SL TX in slot 1. However, in slot 2, the LTE SL RX may only receive power from the LTE SL TX. The specific receive power of the LTE SL RX as illustrated in subfigure B of FIG. 6. Since the LTE SL RX only performs AGC adjustment based on a higher receive power at the beginning of subframe 1, the adjusted gain and parameters are not suitable for receiving a lower receive power, thereby affecting data demodulation of the LTE SL RX. Similarly, in a case where an LTE SL TX transmits data to an LTE SL RX in subframe 1, and an NR SL TX transmits data to an NR SL RX in slot 2, due to overlapping of time-frequency resources, the LTE SL RX may initially receive power from the LTE SL TX in slot 1. However, in subsequent slot 2, the LTE SL RX may receive power from both the LTE SL TX and the NR SL TX. The specific receive power of the LTE SL RX as illustrated in subfigure C of FIG. 6. Since the LTE SL RX only performs AGC adjustment based on a lower receive power at the beginning of subframe 1, the adjusted gain and parameters are not suitable for receiving a higher receive power, thereby affecting data demodulation of the LTE SL RX.

Compared to subfigure B, the condition in subfigure C exerts a more severe impact on LTE SL RX demodulation. Therefore, in the coexistence scenario of LTE SL and NR SL, the NR SL UE is constrained to select resources in at least the first slot corresponding to the LTE SL subframe during resource selection. This avoid selecting resources only in the second slot corresponding to the LTE SL subframe, and thus the LTE SL RX may perform AGC adjustment based on the transmission of NR SL at the beginning of the subframe. Furthermore, the transmit power of the NR SL UE in the second slot is required to be less than its transmit power in the first slot.

### 6. SL Carrier Aggregation (CA)

CA refers to a technique where a communication device aggregates a plurality of carriers together and simultaneously uses these carriers for data transmission, which increases the transmission bandwidth and improves the transmission rate. In LTE V2X, the SL CA based on LTE has been supported. In an NR sidelink, various manufacturers are also considering supporting the SL CA. This is driven by the need to support high data rate scenarios such as advanced driving and extended sensor applications, and by the desire to utilize fragmented spectrum resources and improve spectrum utilization efficiency. For example, FIG. 7 illustrates a schematic diagram of transmission between terminals via CA. Terminal 1 aggregates four carriers, each with a bandwidth of 20 MHz, that is, data is transmitted to terminal 2 via a bandwidth of 80 MHz. For carriers performing CA, the carriers may be located in a same frequency band (intra-band CA) or in different frequency bands (inter-band CA). For example, carrier 1 to carrier 4 in FIG. 7 may belong to a same frequency band or located in different frequency bands. Furthermore, the subcarrier spacing on each carrier may be same or different.

### 7. In-Band Emission (IBE)

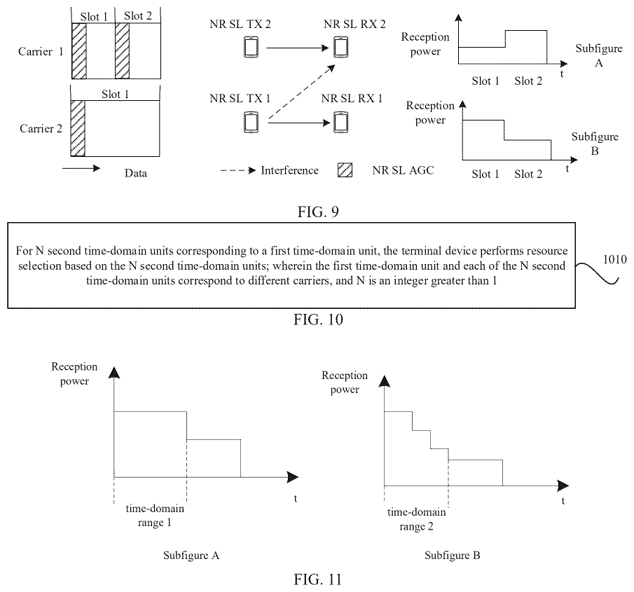

IBE may be understood as adjacent-channel interference. For example, as illustrated in FIG. 8, when a terminal transmits on physical resource block (PRB) 10 to PRB 20, its transmitted power will also be distributed or leaked on other PRBs. In conjunction with FIG. 7, since the emission occurs within the same frequency band, in intra-band SL CA, transmissions on one carrier may also interfere with transmissions on another carrier. For example, terminal 1 performs carrier aggregation transmission on carrier 1 and carrier 2, and terminal 2 performs transmission on carrier 2. The transmission of terminal 1 on carrier 2 may not only interfere with the transmission of terminal 2 on carrier 2, but the transmission of terminal 1 on carrier 1 may also interfere with the transmission of terminal 2 on carrier 2 due to in-band emission.

As described above, in LTE SL and NR SL coexisting on a same carrier, different subcarrier spacings may cause the AGC issue, thereby affecting the demodulation of LTE SL. In SL in-band CA (SL Intra-Band CA), when different carriers have different subcarrier spacings, the same AGC issue may occur due to in-band emission (IBE), thereby affecting NR SL reception on a carrier with a smaller subcarrier spacing.

For example, as illustrated in FIG. 9, the subcarrier spacing on carrier 1 is 30 kHz, and the subcarrier spacing on carrier 2 is 15 kHz. Therefore, one slot on carrier 2 corresponds to two slots on carrier 1. Based on the physical layer structure of NR SL, the NR SL UE only performs AGC at the beginning symbol of the corresponding slot.

In some embodiments, assume that NR SL TX 1 transmits to NR SL RX 1 using carrier aggregation (including carrier 1 and carrier 2), and the transmission occurs in slot 2 on carrier 1 and slot 1 on carrier 2. For reception of NR SL RX 1 on carrier 2, NR SL RX 1 initially receives the transmission from NR SL TX 1 on carrier 2. Subsequently, NR SL RX 1 additionally receives power leaked from the transmission of NR SL TX 1 in slot 2 on carrier 1 to carrier 2 via IBE, resulting in an increase in the receive power of NR SL RX 1 in slot 1 on carrier 2, as illustrated in FIG. 9. Since NR SL RX 1 only performs AGC adjustment based on a lower receive power at the beginning symbol of slot 1 on carrier 2, the adjusted gain and parameters are not suitable for receiving a higher receive power, thereby affecting data demodulation of NR SL RX 1 on carrier 2.

In some embodiments, assume that NR SL TX 1 transmits to NR SL RX 1 using carrier aggregation (including carrier 1 and carrier 2), and the transmission occurs in slot 2 on carrier 1 and slot 1 on carrier 2. Simultaneously, NR SL TX 2 transmits to NR SL RX 2 only on carrier 2, and the transmission occurs in slot 1 on carrier 2. Therefore, NR SL RX 2 initially receives the transmission from both NR SL TX 1 and NR SL TX 2 on carrier 2. Subsequently, NR SL RX 2 additionally receives power leaked from the transmission of NR SL TX 1 in slot 2 on carrier 1 to carrier 2 via IBE, resulting in an increase in the receive power of NR SL RX 2 in slot 1 on carrier 2, as illustrated in FIG. 9. Since NR SL RX 2 only performs AGC adjustment based on a lower receive power at the beginning symbol of slot 1 on carrier 2, the adjusted gain and parameters are not suitable for receiving a higher receive power, thereby affecting data demodulation of NR SL RX 2 on carrier 2.

FIG. 10 illustrates a flowchart of a method for resource selection according to some embodiments of the present disclosure. The method is performed by a terminal device. The method includes the following step 1010 (i.e., S1010).

In S1010, for N second time-domain units corresponding to a first time-domain unit, the terminal device performs resource selection based on the N second time-domain units; wherein the first time-domain unit and each of the N second time-domain units correspond to different carriers, and N is an integer greater than 1.

A time-domain unit is a unit used to describe resources on a time-domain. The time-domain unit may be a slot, a subframe, or other time-domain units, which are not limited herein. The first time-domain unit and the second time-domain unit may be a same type of time-domain units, or may be different types of time-domain units. Illustratively, both the first time-domain unit and the second time-domain unit are slots, or both the first time-domain unit and the second time-domain unit are subframes. Illustratively, the first time-domain unit is a slot while the second time-domain unit is a subframe, or the first time-domain unit is a subframe while the second time-domain unit is a slot.

The first time-domain unit may be any time-domain unit on a carrier corresponding to the first time-domain unit, and the second time-domain unit may be any time-domain unit on a carrier corresponding to the second time-domain unit. The first time-domain unit corresponds to the N second time-domain units.

In some embodiments, the first time-domain unit corresponds to the N second time-domain units, which means that the first time-domain unit and the N second time-domain units occupy a same position in the time domain or occupy a same time-domain resource. This may also be described as the length of the first time-domain unit being equal to the length of the N second time domain units. The length of the time-domain unit refers to a length of a time-domain resource occupied by the time-domain unit.

In some embodiments, a subcarrier spacing for the carrier corresponding to the first time-domain unit is less than a subcarrier spacing for the carrier corresponding to the second time-domain unit. For example, the subcarrier spacing for the carrier corresponding to the first time-domain unit is 15 kHz, and the subcarrier spacing for the carrier corresponding to the second time-domain unit is 30 kHz. As another example, the subcarrier spacing for the carrier corresponding to the first time-domain unit is 15 kHz, and the subcarrier spacing for the carrier corresponding to the second time-domain unit is 60 kHz.

The length of the time-domain resource occupied by the time-domain unit has a negative relationship with the subcarrier spacing for the carrier corresponding to the time-domain unit. The larger the subcarrier spacing for the carrier corresponding to the time-domain unit, the shorter the length of the time-domain resource occupied by the time-domain unit. Since the first time-domain unit corresponds to N second time-domain units, where N is an integer greater than 1, the time-domain resources occupied by the first time-domain unit are longer than the time-domain resources occupied by the second time-domain unit. Therefore, the subcarrier spacing for the carrier corresponding to the first time-domain unit is smaller than the subcarrier spacing for the carrier corresponding to the second time-domain unit.

Next, for convenience, the carrier corresponding to the first time-domain unit is referred to as a first carrier, and the subcarrier spacing for the carrier corresponding to the first time-domain unit is referred to as a first subcarrier spacing. The carrier corresponding to the second time-domain unit is referred to as a second carrier, and the subcarrier spacing for the carrier corresponding to the second time-domain unit is referred to as a second subcarrier spacing. In subsequent embodiments, the above content is not elaborated herein.

In some embodiments, N is determined based on a ratio of the first subcarrier spacing to the second subcarrier spacing. Illustratively, the second subcarrier spacing is N times the first subcarrier spacing. N may be determined based on the first subcarrier spacing and the second subcarrier spacing.

Illustratively, the first subcarrier spacing is 15 kHz, and the second subcarrier spacing is 30 kHz. Then N is 2, that is, one first time domain unit corresponds to two second time domain units.

Illustratively, the first subcarrier spacing is 15 kHz, and the second subcarrier spacing is 60 kHz. Then N is 4, that is, one first time domain unit corresponds to four second time domain units.

In some embodiments, the carrier corresponding to the first time-domain unit and the carrier corresponding to each of the N second time-domain units are located in a same frequency band. The frequency band, or referred to be as bandwidth, denotes a frequency range occupied by a carrier. Illustratively, the frequency band occupies a bandwidth of 80 MHz, and the first carrier and the second carrier each occupy a bandwidth of 20 MHz of 80 MHz. The first carrier is orthogonal to the second carrier.

In some embodiments, the first carrier is a carrier with the smallest subcarrier spacing in the same frequency band. Illustratively, the frequency band includes three carriers, and the subcarrier spacings for carrier 1, 2 and 3 are 15 kHz, 30 kHz, and 60 kHz, respectively. Then the first carrier is carrier 1.

In some embodiments, the first carrier is any carrier in the same frequency band whose subcarrier spacing is less than the subcarrier spacing for the second carrier. Illustratively, the frequency band includes three carriers, and the subcarrier spacings for carrier 1, 2, and 3 are 15 kHz, 30 kHz, and 60 kHz, respectively. The first carrier is carrier 1 in a case where the second carrier is carrier 2. The first carrier is carrier 1 or 2 in a case where the second carrier is carrier 3.

In some embodiments, for the N second time-domain units corresponding to the first time-domain unit, the terminal device performs resource selection based on the resource status of the N second time-domain units.

The resource status of the N second time-domain units, may be understood as transmission resources that are occupied or reserved (where “reserved” may also be referred to as “indicated”) in the N second time-domain units, or as transmission resources that are unoccupied or unreserved (where “unreserved” may also be referred to as “unindicated”) in the N second time-domain units.

In some embodiments, the resource status of the N second time-domain units may be determined via resource sensing.

In some embodiments, for the N second time-domain units corresponding to the first time-domain unit, the terminal device performs resource selection from the N second time-domain units based on the N second time-domain units. Illustratively, the terminal device performs resource selection from the N second time-domain units based on the resource status of the N second time-domain units. Illustratively, the terminal device performs resource selection from the N second time-domain units based on the idle transmission resources of the N second time-domain units. Illustratively, the terminal device performs resource selection from the N second time-domain units based on the occupied or reserved transmission resources of the N second time-domain units.

In some embodiments, for the N second time-domain units corresponding to the first time-domain unit, the terminal device performs resource selection from the first time-domain unit based on the N second time-domain units. Illustratively, the terminal device performs resource selection from the first time-domain unit based on the resource status of the N second time-domain units. Illustratively, the terminal device performs resource selection from the first time-domain unit based on the idle transmission resources of the N second time-domain units. Illustratively, the terminal device performs resource selection from the first time-domain unit based on the occupied or reserved transmission resources of the N second time-domain units.

In the technical solutions according to the embodiments of the present disclosure, in an SL carrier aggregation scenario, for N second time-domain units corresponding to a first time-domain unit, a terminal device performs resource selection based on the N second time-domain units. This may prevent the impact of in-band emission on transmissions of the first time-domain unit in a case where the terminal device performs data transmission from the N second time-domain units. Specifically, this may avoid fluctuations in transmit power in the first time-domain unit with a smaller subcarrier spacing. This, in turn, helps improve the accuracy of AGC training on carriers with a smaller subcarrier spacing in a multi-carrier scenario, thereby improving the reliability of data transmission on those carriers.

For performing resource selection from the N second time-domain units and performing resource selection from the first time-domain unit, the present disclosure provides some embodiments.

### Content 1. Performing Resource Selection From the N Second Time-Domain Units

In some embodiments, the terminal device selects resources from at least first M second time-domain units of the N second time-domain units in a case where the terminal device selects transmission resources from the N second time-domain units, wherein M is a positive integer less than or equal to N.

In some embodiments, the terminal device only selects resources from the first M second time-domain units of the N second time-domain units in a case where the terminal device selects transmission resources from the N second time-domain units.

Illustratively, N is 2. The terminal device selects resources from at least first M second time-domain units of two second time-domain units in a case where the terminal device selects transmission resources from the two second time-domain units. In this case, the value of M may be 1 or 2. When M is equal to 1, the terminal device only selects resources from the first second time-domain unit. When M is equal to 2, the terminal device selects resources from the first and second second time-domain units.

Illustratively, N is 4. The terminal device selects resources from at least first M second time-domain units of four second time-domain units in a case where the terminal device selects transmission resources from the four second time-domain unis. In this case, the value of M may be 1, 2, 3, or 4. When M is equal to 1, the terminal device only selects resources from the first second time-domain unit. When M is equal to 2, the terminal device selects resources from the first two second time-domain units. When M is equal to 3, the terminal device selects resources from the first three second time-domain units. When M is equal to 4, the terminal device selects resources from the four second time-domain units.

In some embodiments, the terminal device selects resources from at least first M second time-domain units of the N second time-domain units in a case where the terminal device selects transmission resources from the N second time-domain units. The selection of resources in time domain units other than the first M second time domain units depends on the implementation of the terminal device itself.

Illustratively, N is 2. The terminal device selects resources from at least first M second time-domain units of two second time-domain units in a case where the terminal device selects transmission resources from the two second time-domain units. In this case, the value of M may be 1 or 2. When M is equal to 1, the terminal device selects resources from the first second time-domain unit, or the terminal device selects resources from the first and second second time-domain units. When M is equal to 2, the terminal device selects resources from the first and second second time-domain units.

Illustratively, N is 4. The terminal device selects resources from at least first M second time-domain units of four second time-domain units in a case where the terminal device selects transmission resources from the four second time-domain unis. In this case, the value of M may be 1, 2, 3, or 4. When M is equal to 1, the terminal device selects resources from the first second time-domain unit, and the selection of remaining three second time-domain units depends on the implementation of the terminal device. When M is equal to 2, the terminal device selects resources from the first two second time-domain units, and the selection of remaining two second time-domain units depends on the implementation of the terminal device. When M is equal to 3, the terminal device selects resources from the first three second time-domain units, and the selection of remaining one second time-domain unit depends on the implementation of the terminal device. When M is equal to 4, the terminal device selects resources from the four second time-domain units.

In some embodiments, M may be configured by the network, or preconfigured or predefined, or may depends on the implementation of the terminal device itself, which are not limited herein. Illustratively, M=1, or M=N−1.

In some embodiments, transmit power corresponding to the transmission resources selected from the N second time-domain units is identical or decreasing. Illustratively, the terminal device only selects transmission resources from the first M time-domain of the N second time-domain units, then the transmit power corresponding to the transmission resources selected from the first M time-domain of the N second time-domain units is identical or decreasing.

As described in the related technology section, in a case where a receiver terminal device receives data transmitted on the first time-domain unit, performing AGC adjustments based on a higher receive power at the beginning symbol of the first time-domain unit has less impact on subsequent data demodulation compared to performing AGC adjustments based on a lower receive power at the beginning symbol of the first time-domain unit. Illustratively, the two cases described above may be applied to the following examples:

Case 1: As illustrated in FIG. 9, in a case where NR SL TX 1 transmits data to NR SL RX 1 using carrier aggregation (including carrier 1 and carrier 2), and the transmission occurs in slot 2 on carrier 1 and slot 1 on carrier 2. For reception of NR SL RX 1 on carrier 2, NR SL RX 1 initially receives the transmission from NR SL TX 1 on carrier 2. Subsequently, NR SL RX 1 additionally receives power leaked from the transmission of NR SL TX 1 in slot 2 on carrier 1 to carrier 2 via IBE, resulting in an increase in the receive power of NR SL RX 1 in slot 1 on carrier 2, as illustrated in subfigure A of FIG. 9. Since NR SL RX 1 only performs AGC adjustment based on a lower receive power at the beginning symbol of slot 1 on carrier 2, the adjusted gain and parameters are not suitable for receiving a higher receive power, thereby affecting data demodulation of NR SL RX 1 on carrier 2. Carrier 1 corresponds to the second carrier, and the slot of carrier 1 corresponds to the second time-domain unit. Carrier 2 corresponds to the first carrier, and the slot of carrier 2 corresponds to the first domain unit.

Case 2: As illustrated in FIG. 9, in a case where NR SL TX 1 transmits data to NR SL RX 1 using carrier aggregation (including carrier 1 and carrier 2), and the transmission occurs in slot 1 on carrier 1 and slot 1 on carrier 2. For reception of NR SL RX 1 on carrier 2, NR SL RX 1 initially receives the transmission from NR SL TX 1 on carrier 2 and power leaked from the transmission of NR SL TX 1 in slot 1 on carrier 1 to carrier 2 via IBE. Subsequently, NR SL RX 1 no longer receives power leaked from the transmission of NR SL TX 1 in slot 2 on carrier 1 to carrier 2 via IBE, resulting in a decrease in the receive power of NR SL RX 1 in slot 1 on carrier 2, as illustrated in subfigure B of FIG. 9. Since NR SL RX 1 only performs AGC adjustment based on a higher receive power at the beginning symbol of slot 1 on carrier 2, the adjusted gain and parameters are not suitable for receiving a lower receive power, thereby affecting data demodulation of NR SL RX 1 on carrier 2. Carrier 1 corresponds to the second carrier, and the slot of carrier 1 corresponds to the second time-domain unit. Carrier 2 corresponds to the first carrier, and the slot of carrier 2 corresponds to the first domain unit.

Compared to Case 1, Case 2 exerts a smaller impact on data demodulation on carrier 2. Therefore, avoiding the phenomenon described in Case 1 may reduce the impact on data demodulation on the first carrier to some extent. Based on this, the transmit power corresponding to the transmission resources selected from the N second time-domain units is identical or decreasing. This allows the receiver terminal device to exhibit a receive power pattern as illustrated in subfigure A of FIG. 11 or as illustrated in subfigure B in FIG. 11 in a case where the receiver terminal device receives data transmitted on the first carrier. Wherein time-domain range 1 of the first time-domain unit in subfigure A of FIG. 11, and time-domain range 2 of the first time-domain unit in subfigure B of FIG. 11 corresponds to the first M second time-domain units of N second time-domain units. Illustratively, N is equal to 2, and the terminal device has determined transmission resources from both of the two second time-domain units corresponding to the first time-domain unit, then the transmit power corresponding to the transmission resources of the second second time-domain unit should be no greater than the transmit power corresponding to the transmission resources of the first second time-domain unit. Illustratively, N is equal to 4, and the terminal device has determined transmission resources from the first two second time-domain units of the four second time-domain units corresponding to the first time-domain unit, then the transmit power corresponding to the transmission resources of the second second time-domain unit should be no greater than the transmit power corresponding to the transmission resources of the first second time-domain unit.

In some embodiments, in a case where the first time-domain unit does not include occupied or reserved transmission resources, the receiver terminal device does not need to perform data reception on the first time-domain unit of the first carrier. In other words, regardless of how resources are selected in the resources of the N second time-domain units on the second carrier, there is no impact on the data demodulation of the receiver terminal device on the first carrier.

In some embodiments, the first time-domain unit satisfies at least one of the following conditions:
the first time-domain unit includes transmission resources already selected by the terminal device; and
the first time-domain unit includes transmission resources determined based on sensed first sidelink control information.

In some embodiments, the first time-domain unit includes the transmission resources already selected by the terminal device. In other words, the first time-domain unit includes occupied resources.

In some embodiments, the first time-domain unit includes the transmission resources determined based on the sensed first sidelink control information. In other words, the first time-domain unit includes reserved resources. The transmission resources determined based on sensed first sidelink control information are transmission resources indicated by the first sidelink control information. Illustratively, the transmission resources indicated by the first sidelink control information are resources indicated by the Time Resource Assignment, Frequency Resource Assignment and Resource Reservation Period fields. Illustratively, the resources indicated by the first sidelink control information are resources indicated by the Time Resource Assignment and Frequency Resource Assignment fields.

In some embodiments, the first time-domain unit may include both the transmission resources selected by the terminal device and the resources or transmission resources determined based on sensed first sidelink control information.

In some embodiments, a signal quality corresponding to the first sidelink control information is greater than a first threshold. In some embodiments, the signal quality corresponding to the first sidelink control information is SL-RSRP, then the SL-RSRP corresponding to the first sidelink control information is greater than an SL-RSRP threshold.

In some embodiments, “the signal quality corresponding to the first sidelink control information is greater than the first threshold” means that the signal quality of PSCCH bearing the first sidelink control information is greater than the first threshold, or the signal quality of PSSCH scheduled by the PSCCH is greater than the first threshold.

In some embodiments, the terminal device selects transmission resources from the N second time-domain units in a case where the terminal device selects transmission resources from a first resource set upon resource exclusion, wherein the first resource set includes at least one resource on a carrier corresponding to the N second time-domain units.

In some embodiments, the first resource set may be determined using the following resource exclusion method. The method may include at least one of the following steps 1 to 3. And the first resource set corresponds to resource set A in the steps 1 to 3.

In step 1, the terminal device determines a resource selection window and a resource sensing window. The terminal device initializes resource set A to include all candidate resources in the resource selection window, where a candidate resource refers to a resource located in any the second time-domain unit on the second carrier. At this point, the number of candidate resources in resource set A is Mₜₒₜₐₗ.

In step 2, the terminal device performs resource exclusion on resource set A based on an unmonitored slot and/or sensed first sidelink control information. Specifically, in a case where the candidate resources or period resources corresponding to the candidate resources are overlapped with a slot determined based on the unmonitored slot, then the candidate resources are determined as excluded resources and are removed from resource set A. In a case where the candidate resources or period resources corresponding to the candidate resources are overlapped with resources determined based on the sensed first sidelink control information, and the signal quality corresponding to the first sidelink control information is greater than the first threshold, then the candidate resources are determined as the excluded resources and are removed from resource set A.

In step 3, in a case where the number of remaining candidate resources in resource set A upon resource exclusion is less than W*Mₜₒₜₐₗ, then the first threshold is raised and resource set A is initialized. The resource exclusion is performed again until the number of remaining candidate resources in resource set A upon resource exclusion is greater than or equal to W*Mₜₒₜₐₗ.

W is configured by the network within a resource pool. The terminal device then determines the value of W from the values configured in the resource pool based on a priority of data to be transmitted. The determined value of W is indicated to a physical layer by a high layer of the terminal device. The high layer refers to a layer above the physical layer, such as a medium access control (MAC) layer.

Taking the first threshold as an SL-RSRP threshold as an example, in a case where the number of remaining candidate resources in resource set A upon resource exclusion is less than W*Mₜₒₜₐₗ, then the SL-RSRP threshold is raised by 3 dB and resource set A is initialized. The resource exclusion is performed again until the number of remaining candidate resources in resource set A upon resource exclusion is greater than or equal to W*Mₜₒₜₐₗ.

In some embodiments, the carrier corresponding to the first time-domain unit is a carrier selected by the terminal device within a same frequency band for data transmission or carrier aggregation.

In some embodiments, the carrier corresponding to the first time-domain unit has at least one transmission resource already selected by the terminal device.

Using the above method, in a case where transmission resources are occupied or reserved by the terminal device in the first time-domain unit, resource selection is performed in the N second time-domain units. This aims to maintain an identical or a decreasing receive power for data transmitted on the first time-domain unit of the first carrier, so that the AGC gain modulated by the receiver terminal device at the beginning symbol of the first time-domain unit is suitable for receiving data on the first time-domain unit, decreasing the impact on the data demodulation on the first carrier.

For the method described in Content 1, the present disclosure provides some embodiments. In some embodiments, as illustrated in FIG. 12, for example, both the first time-domain unit and the second time-domain unit are slots, carrier 1 corresponds to the first carrier, and carrier 2 corresponds to the second carrier.

Carrier 1 and carrier 2 are located within a same frequency band. The subcarrier spacing on carrier 1 is 15 kHz, while the subcarrier spacing on carrier 2 is 30 kHz. Therefore, one slot of carrier 1 corresponds to two slots of carrier 2 in the time domain. The terminal device determines a resource selection window and a resource sensing window on carrier 2. And the terminal device initializes resource set A to include all candidate resources in the resource selection window, where the candidate resources are located on carrier 2. The terminal device performs resource exclusion on resource set A based on the unmonitored slot and/or sensed first sidelink control information in the resource sensing window, and then determines the transmission resources from resource set A upon resource exclusion.

In some embodiments, when the terminal device determines the transmission resources from resource set A upon resource exclusion, in a case where resources are determined in two slots on carrier 2 corresponding to any one slot on carrier 1, it is required that the selected resources are located at least in the first slot of the two slots on carrier 2. In other words, the determined transmission resources should not be located only in the second slot of the two slots on carrier 2. For example, for any slot 1 on carrier 1, transmission resources are determined in both of the corresponding two slots on carrier 2. As another example, for any slot 2 on carrier 1, the resources in the first slot of the corresponding two slots on carrier 2 are determined as the transmission resources. The method is used to avoid potential AGC issues affecting the receive power on the first time-domain unit of the first carrier for receiver terminal devices due to possible IBE.

In some embodiments, when the terminal device determines the transmission resources from resource set A upon resource exclusion, in a case where resources are determined in the two slots on carrier 2 corresponding to any one slot on carrier 1 that satisfies a first condition, it is required that the selected resource is located at least in the first slot of the two slots on carrier 2. In other words, the determined transmission resources should not be located only in the second slot of two slots on carrier 2. The first condition is that the slot on carrier 1 has at least one time-frequency resource already selected by a terminal. For example, for any slot 1 on carrier 1 including at least one resource already selected by the terminal, transmission resources are determined in both of the corresponding two slots on carrier 2. As another example, for any slot 2 on carrier 1 including at least one resource already selected by the terminal, the resources in the first slot of the corresponding two slots on carrier 2 are determined as the transmission resources. In a case where the terminal device needs to transmit data on the first time-domain unit on the first carrier, the method is used to avoid potential AGC issues affecting the receive power on the first time-domain unit on the first carrier for receiver terminal devices due to possible IBE.

In some embodiments, when the terminal device determines the transmission resources from resource set A upon resource exclusion, in a case where resources are determined in the two slots on carrier 2 corresponding to any one slot on carrier 1 that satisfies a first condition, it is required that the selected resource is located at least in the first slot of the two slots on carrier 2. In other words, the determined transmission resources should not be located only in the second slot of two slots on carrier 2. The first condition is that the slot on carrier 1 has at least one time-frequency resource determined by a terminal based on the sensed first sidelink control information. For example, for any slot 1 on carrier 1 including at least one reserved resource for other terminals, transmission resources are determined in both of the corresponding two slots on carrier 2. As another example, for any slot 2 on carrier 1 including at least one reserved resource for other terminals, the resources in the first slot of the corresponding two slots on carrier 2 are determined as the transmission resources. In a case where reserved resources exist on the first time-domain unit of the first carrier, the method is used to avoid potential AGC issues affecting the receive power on the first time-domain unit on the first carrier for receiver terminal devices due to possible IBE.

In some embodiments, when the terminal device determines the transmission resources from resource set A upon resource exclusion, in a case where resources are determined in the two slots on carrier 2 corresponding to any one slot on carrier 1 that satisfies a first condition, it is required that the selected resource is located at least in the first slot of the two slots on carrier 2. In other words, the determined transmission resources should not be located only in the second slot of two slots on carrier 2. The first condition is that the slot on carrier 1 has at least one time-frequency resource determined by a terminal based on the sensed first sidelink control information and the SL-RSRP corresponding to the first sidelink control information is greater than an SL-RSRP threshold. For example, for any slot 1 on carrier 1 that has at least one reserved resource for other terminals and satisfies the SL-RSRP threshold condition, transmission resources are determined in both of the corresponding two slots on carrier 2. As another example, for any slot 2 on carrier 1 that has at least one reserved resource for other terminals and satisfies the SL-RSRP threshold condition, the resources in the first slot of the corresponding two slots on carrier 2 are determined as the transmission resources. In a case where reserved resources exist on the first time-domain unit on the first carrier, and the reserved transmission resources are excluded from the candidate transmission resources of the terminal device, the method is used to avoid potential AGC issues affecting the receive power on the first time-domain unit on the first carrier for receiver terminal devices due to possible IBE.

### Content 2. Performing Resource Selection in the First Time-Domain Unit

In some embodiments, the terminal device avoids selecting resources from the first time-domain unit in a case where no transmission resources are available in first X second time-domain units of the N second time-domain units, wherein X is a positive integer.

Illustratively, N is 2. The terminal device avoids selecting resources from the first time-domain unit in a case where no transmission resources are available in first X second time-domain units of the two second time-domain units. In this case, the value of X may be 1 or 2. In other words, the terminal device avoids selecting resources from the first time-domain unit corresponding to the two second time-domain units in a case where no transmission resources are available in the first second time-domain unit of the two second time domain units.

Illustratively, N is 4. The terminal device avoids selecting resources from the first time-domain unit in a case where no transmission resources are available in first X second time-domain units of the four second time-domain units. In this case, the value of X may be 1, 2, 3, or 4. In other words. In a case where no transmission resources are available in the first second time-domain unit of the four second time domain units, or in a case where no transmission resources are available in the first second second time-domain units of the four second time-domain units, or in a case where no transmission resources are available in the first three second time-domain units of the four second time-domain units, then the terminal device avoids selecting resources from the first time-domain unit corresponding to the four second time-domain units.

In some embodiments, X may be configured by the network, or preconfigured or predefined, or may depends on the implementation of the terminal device, which are not limited herein.

In some embodiments, the terminal device avoids selecting resources from the first time-domain unit in a case where the transmit power corresponding to available transmission resources from the N second time-domain units is increasing. Illustratively, in a case where transmission resources are available in the first X second time-domain units of the N second time-domain units and the transmit power corresponding to the transmission resources is increasing, then the terminal device avoids selecting resources from the first time-domain unit. Details regarding the section may be referred to the description in the related technology section or the description in content 1, which are not repeated herein.

In some embodiments, the terminal device avoids selecting resources from the first time-domain unit in a case where no transmission resources are available in the first X second time-domain units of the N second time-domain units, and transmission resources are available in the last Y second time-domain units, wherein Y is a positive integer.

In a case where no transmission resources are available in the N second time-domain units, the receiver terminal device may not be affected by the IBE from the second time-domain unit when the receiving data on the first time-domain unit, and the data demodulation of the receiver terminal device on the first carrier may not be affected.

In some embodiments, Y may be configured by the network, or preconfigured or predefined, or may depend on the implementation of the terminal device, which are not limited herein.

In some embodiments, the sum of X and Y is equal to N. Illustratively, X=1, and Y=N−1.

In some embodiments, the transmission resources are transmission resources already selected by the terminal device. In other words, the transmission resources are transmission resources occupied by the terminal device.

In some embodiments, the transmission resources are transmission resources determined by the terminal device based on sensed first sidelink control information. In other words, the transmission resources are transmission resources occupied by the terminal device. The transmission resources determined based on sensed first sidelink control information are transmission resources indicated by the first sidelink control information. Illustratively, the resources indicated by the first sidelink control information are resources indicated by the Time Resource Assignment, Frequency Resource Assignment and Resource Reservation Period fields. Illustratively, the resources indicated by the first sidelink control information are resources indicated by the Time Resource Assignment and Frequency Resource Assignment fields.

In some embodiments, the transmission resources may include the transmission resources already selected by the terminal device and the transmission resources determined by the terminal device based on sensed first sidelink control information.

In some embodiments, a signal quality corresponding to the first sidelink control information is greater than a second threshold. In some embodiments, the signal quality corresponding to the first sidelink control information is SL-RSRP, and then the SL-RSRP corresponding to the first sidelink control information is greater than an SL-RSRP threshold.

In some embodiments, “the signal quality corresponding to the first sidelink control information is greater than the second threshold” means that the signal quality of PSCCH bearing the first sidelink control information is greater than the second threshold, or the signal quality of PSSCH scheduled by the PSCCH is greater than the second threshold.

In some embodiments, the terminal device avoids selecting resources from the first time-domain unit when selecting transmission resources from a second resource set. No transmission resources are available in the first X second time-domain units of the N second time-domain units corresponding to the first time-domain unit. The second resource set is a resource set determined via resource selection on the carrier corresponding to the first time-domain unit.

In some embodiments, the second resource set is determined based on resource sensing. Illustratively, the second resource set may be determined by referring to steps 1 to 3 in the content 1. For example, the second resource set may be resource set A from steps 1 to 3. Resource set A is initialized to include candidate resources on the first carrier. Upon resource exclusion based on unmonitored slots and/or sensed first sidelink control information, the resulting resource set A is designated as the second resource set.

In some embodiments, the terminal device excludes all candidate resources from the first time-domain unit when performing resource exclusion on the second resource set, and then selects transmission resources from the second resource set upon resource exclusion. No transmission resources are available in the first X second time-domain unit of the N second time-domain units corresponding to the first time-domain unit.

By excluding all candidate resources from the first time-domain unit, the second resource set is obtained. Resource selection is then performed in the second resource set. This prevents the terminal device to select resources from the first time-domain unit, thereby achieving the goal of avoiding selecting resources from the first time-domain unit.

In some embodiments, the carrier corresponding to the N second time-domain units is a carrier selected by the terminal device within a same frequency band for data transmission or carrier aggregation.

In some embodiments, the carrier corresponding to the N second time-domain units has at least one transmission resource already selected by the terminal device.

Using the above method, in a case where no occupied or reserved transmission resources are available in the first X second time-domain units of the N second time-domain units, resource selection in the first time-domain unit is avoided. This aims to maintain an identical or a decreasing receive power for data transmitted on the first time-domain unit on the first carrier, so that the AGC gain modulated by the receiver terminal device at the beginning symbol of the first time-domain unit is suitable for receiving data on the first time-domain unit, decreasing the impact on the data demodulation on the first carrier.

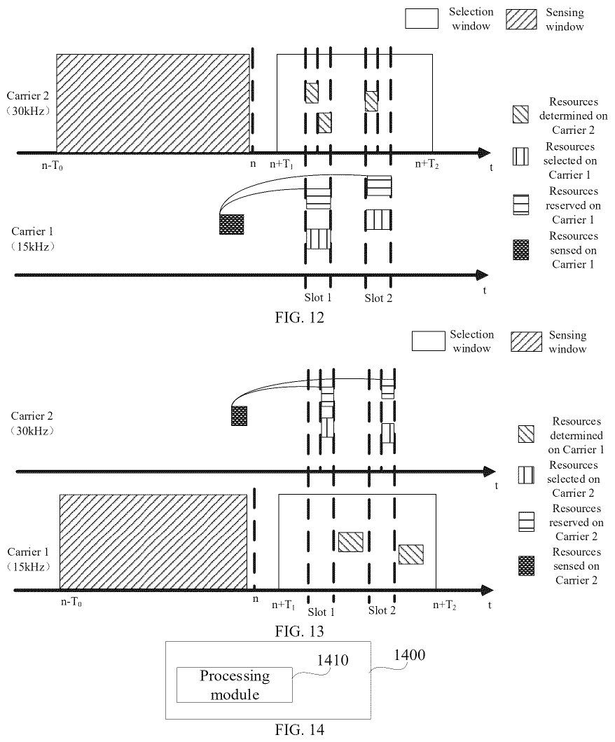

For the method described in the content 2, the present disclosure provides some embodiments. In some embodiments, as illustrated in FIG. 13, for example, both the first time-domain unit and the second time-domain unit are slots, carrier 1 corresponds to the first carrier, and carrier 2 corresponds to the second carrier.

Carrier 1 and carrier 2 are located within a same frequency band. The subcarrier spacing on carrier 1 is 15 kHz, while the subcarrier spacing on carrier 2 is 30 kHz. Therefore, one slot of carrier 1 corresponds to two slots of carrier 2 in the time domain. A terminal device determines a resource selection window and a resource sensing window on carrier 1. And the terminal device initializes a resource set A to include all candidate resources in the resource selection window, where the candidate resources are located on carrier 1. The terminal device performs resource exclusion on resource set A based on the unmonitored slot and/or sensed first sidelink control information in the resource sensing window, and then determines the transmission resources from resource set A upon resource exclusion.

In some embodiments, in a case where the first of the two slots on carrier 2 corresponding to any one slot on carrier 1 has no transmission resources already selected by the terminal device, while the second slot has transmission resources already selected by the terminal, then the terminal device avoids selecting transmission resources in the slot on carrier 1. For example, for any slot 1 on carrier 1, the first of the corresponding two slots on carrier 2 has no resources already selected by the terminal, while the second slot has transmission resources already selected by the terminal device. For any slot 2 on carrier 1, the first of the corresponding two slots on carrier 2 has no resources already selected by the terminal device, while the second slot has transmission resources already selected by the terminal device. Therefore, when the terminal device determines the transmission resources in a resource set A, the terminal device avoids selecting transmission resources in slot 1 and slot 2, or the terminal device excludes all candidate resources in slot 1 and slot 2 when performing resource exclusion on resource set A. The resulting transmission resources determined by the terminal on carrier 1 are illustrated in FIG. 13. The method is used to avoid potential AGC issues affecting the receive power on the first time-domain unit on the first carrier for receiver terminal devices due to possible IBE.

In some embodiments, in a case where the first of the two slots on carrier 2 corresponding to any one slot on carrier 1 has no transmission resources determined based on the sensed first sidelink control information by the terminal device, while the second slot has transmission resources determined based on the sensed first sidelink control information by the terminal device, then the terminal device avoids selecting transmission resources in the slot on carrier 1. For example, for any slot 1 on carrier 1, the first of the corresponding two slots on carrier 2 has no reserved resources for other terminal devices, while the second slot has reserved resources for other terminal devices. For any slot 2 on carrier 1, the first of the corresponding two slots on carrier 2 has no reserved resources for other terminal devices, while the second slot has reserved resources for other terminal devices. Therefore, when the terminal device determines the transmission resources in a resource set A, the terminal device avoids selecting transmission resources in slot 1 and slot 2, or the terminal device excludes all candidate resources in slot 1 and slot 2 when performing resource exclusion on resource set A. The resulting transmission resources determined by the terminal device on carrier 1 are illustrated in FIG. 13. When the last Y second time-domain units of the N time-domain units on the second carrier have reserved transmission resources, while the first X second time-domain units do not have reserved transmission resources, the method is used to avoid potential AGC issues affecting the receive power on the first time-domain unit on the first carrier for receiver terminal devices due to possible IBE.

In some embodiments, in a case where the first of the two slots on carrier 2 corresponding to any one slot on carrier 1 has no transmission resources determined based on the sensed first sidelink control information by the terminal device, while the second slot has transmission resources determined based on the sensed first sidelink control information by the terminal device, and the SL-RSRP corresponding to the fist sidelink control information is greater than the SL-RSRP threshold, then the terminal device avoids selecting transmission resources in the slot on carrier 1. For example, for any slot 1 on carrier 1, the first of the corresponding two slots on carrier 2 has no reserved resources for other terminal devices, while the second slot has reserved resources for other terminal devices, and the SL-RSRP corresponding to the fist sidelink control information is greater than the SL-RSRP threshold. For any slot 2 on carrier 1, the first of the corresponding two slots on carrier 2 has no reserved resources for other terminal devices, while the second slot has reserved resources for other terminal devices, and the SL-RSRP corresponding to the fist sidelink control information is greater than the SL-RSRP threshold. Therefore, when the terminal device determines the transmission resources in a resource set A, the terminal device avoids selecting transmission resources in slot 1 and slot 2, or the terminal device excludes all candidate resources in slot 1 and slot 2 when performing resource exclusion on resource set A. The resulting transmission resources determined by the terminal device on carrier 1 are illustrated in FIG. 13. When the last Y second time-domain units of the N time-domain units on the second carrier have reserved transmission resources, while the first X second time-domain units do not have reserved transmission resources, the method is used to avoid potential AGC issues affecting the receive power on the first time-domain unit on the first carrier for receiver terminal devices due to possible IBE.

The following embodiments are apparatus embodiments of the present disclosure that are used to implement the method embodiments of the present disclosure. For details that are not disclosed in the apparatus embodiments of the present disclosure, reference may be made to the method embodiments of the present disclosure.

FIG. 14 illustrates a block diagram of an apparatus for resource selection according to some embodiments of the present disclosure. The apparatus has functions for implementing the method for resource selection, and the functions may be implemented via hardware, or by implementing corresponding software on hardware. The apparatus may be the terminal device described above, or may be configured within the terminal device. As illustrated in FIG. 14, the apparatus 1400 includes: a processing module 1410.

The processing module 1410 is configured to, for N second time-domain units corresponding to a first time-domain unit, perform resource selection based on the N second time- domain units; wherein the first time-domain unit and each of the N second time-domain units correspond to different carriers, and N is an integer greater than 1.

In some embodiments, the processing module 1410 is configured to select resources from at least first M second time-domain units of the N second time-domain units in a case where the terminal device selects transmission resources from the N second time-domain units, wherein M is a positive integer less than or equal to N.

In some embodiments, transmit power corresponding to the transmission resources selected from the N second time-domain units is identical or decreasing.

In some embodiments, the first time-domain unit satisfies at least one of the following conditions: the first time-domain unit includes transmission resources already selected by the terminal device; and the first time-domain unit includes transmission resources determined based on sensed first sidelink control information.

In some embodiments, a signal quality corresponding to the first sidelink control information is greater than a first threshold.

In some embodiments, the processing module 1410 is configured to select transmission resources from the N second time-domain units in a case where the terminal device selects transmission resources from a first resource set upon resource exclusion, wherein the first resource set includes at least one resource on a carrier corresponding to the N second time-domain units

In some embodiments, a carrier corresponding to the first time-domain unit is a carrier selected by the terminal device within a same frequency band for data transmission or carrier aggregation; and/or the carrier corresponding to the first time-domain unit has at least one transmission resource already selected by the terminal device.

In some embodiments, the processing module 1410 is configured to avoid selecting resources from the first time-domain unit in a case where no transmission resources are available in first X second time-domain units of the N second time-domain units, wherein X is a positive integer.

In some embodiments, the processing module 1410 is configured to avoid selecting resources from the first time-domain unit in a case where no transmission resources are available in the first X second time-domain units of the N second time-domain units, and transmission resources are available in the last Y second time-domain units, wherein Y is a positive integer.

In some embodiments, the transmission resources are transmission resources already selected by the terminal device; or the transmission resources are transmission resources determined by the terminal device based on sensed first sidelink control information.

In some embodiments, a signal quality corresponding to the first sidelink control information is greater than a second threshold.

In some embodiments, the processing module 1410 is configured to avoid selecting resources from the first time-domain unit when selecting transmission resources from a second resource set; or exclude all candidate resources from the first time-domain unit when performing resource exclusion on the second resource set, and then select transmission resources from the second resource set upon resource exclusion; wherein the second resource set includes at least one resource on a carrier corresponding to the first time-domain unit.

In some embodiments, a carrier corresponding to the N second time-domain units is a carrier selected by the terminal device within a same frequency band for data transmission or carrier aggregation; and/or the carrier corresponding to the N second time-domain units has at least one transmission resource already selected by the terminal device.

In some embodiments, a subcarrier spacing for the carrier corresponding to the first time-domain unit is less than a subcarrier spacing for the carrier corresponding to the N second time-domain units.

In some embodiments, the carrier corresponding to the first time-domain unit and the carrier corresponding to the N second time-domain units are located in a same frequency band.

The technical solutions provided in the embodiments of the present disclosure, in an SL carrier aggregation scenario, for N second time-domain units corresponding to a first time-domain unit, a terminal device performs resource selection based on the N second time-domain units. This may prevent the impact of in-band emission on transmissions of the first time-domain unit in a case where the terminal device performs data transmission from the N second time-domain units. Specifically, this may avoid fluctuations in transmit power in the first time-domain unit with a smaller subcarrier spacing. This, in turn, helps improve the accuracy of AGC training on carriers with a smaller subcarrier spacing in a multi-carrier scenario, thereby improving the reliability of data transmission on those carriers.

It should be noted that when implementing the functions of the apparatus according to the above embodiments, the division of the various functional modules is merely exemplary. In practical applications, the above functions may be assigned to different functional modules according to actual needs, i.e., the content structure of the device may be divided into different functional modules to accomplish all or part of the above functions.

With regard to the apparatus in the aforementioned embodiments, the specific mode in which each module performs the operation has been described in detail in the embodiments related to the method, which are not described herein any further. For details not described in detail in the apparatus embodiment, reference may be made to the method embodiment described above.

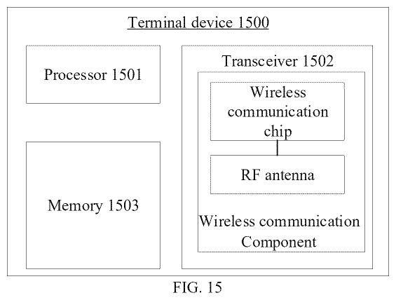

FIG. 15 illustrates a schematic structural diagram of a terminal device according to some embodiments of the present disclosure. The terminal device 1500 includes: a processor 1501, a transceiver 1502, and a memory 1503. The transceiver 1502 is configured to implement transmission and reception functions, while the processor 1501 is configured to implement other processing functions or to control transmission and/or reception, such as by implementing the functions of the processing module 1401.

The processor 1501 includes one or more processing cores, and executes various functional applications and information processing by running software programs and modules.

The transceiver 1502 may include a receiver and a transmitter. For example, the receiver and transmitter may be implemented as a common wireless communication component, which may include a wireless communication chip and a radio frequency antenna.

The memory 1503 may be communicably connected to the processor 1501 and the transceiver 1502.

The memory 1503 may be configured to store one or more computer programs loaded and run by the processors, and the processor 1501 is configured to load and run the one or more computer programs to perform the steps in the above method embodiments.

In some embodiments, the processor 1501 is configured to, for N second time-domain units corresponding to a first time-domain unit, perform resource selection based on the N second time-domain units; wherein the first time-domain unit and each of the N second time-domain units correspond to different carriers, and N is an integer greater than 1.

For details not described in the embodiments, reference may be made to the descriptions in the above embodiments, which are not described herein any further.

In addition, the memory may be implemented by any type or combination of volatile or non-volatile storage devices, including, but not limited to: a magnetic or optical disc, an electrically erasable programmable read-only memory, an erasable programmable read-only memory, a static random-access memory, a read-only memory (ROM), a magnetic memory, a flash memory, and a programmable read-only memory.

The embodiments of the present disclosure further provide a computer-readable storage medium storing one or more computer programs therein. The one or more computer programs, when loaded and run by a processor, cause the processor to perform the method for resource selection. In some embodiments, the computer-readable storage medium includes: a ROM, a random-access memory (RAM), a solid-state drive (SSD), an optical disk, or the like. The RAM includes a resistance random-access memory (ReRAM) and a dynamic random access memory (DRAM).

The embodiments of the present disclosure further provide a chip including programmable logic circuitry and/or one or more program instructions. The chip, when running, is configured to perform the method for resource selection.

The embodiments of the present disclosure further provide a computer program product. The computer program product includes one or more computer instructions stored in a computer-readable storage medium. The one or more computer instructions, when read from the computer-readable storage medium and executed by a processor, causes the processor to perform the method for resource selection.

It should be understood that the term “indication” mentioned in the embodiments of the present disclosure is a direct indication, an indirect indication, or an indication that there is an association relationship. For example, A indicates B, which may mean that A indicates B directly, e.g., B may be acquired by A; or that A indicates B indirectly, e.g., A indicates C by which B may be acquired; or that an association relationship is present between A and B.

In the description of the embodiments of the present disclosure, the term “correspond” indicates a direct or indirect corresponding relationship between two items, or indicates an associated relationship between the two items; and also indicates relationships such as indicating and being indicated, or configuring and being configured.

In some embodiments of the present disclosure, the term “predefined” is implemented by pre-storing corresponding codes, tables, or other means that may be defined to indicate related information in devices (including, for example, terminal devices and network devices), and the present disclosure does not limit the specific implementation thereof. For example, “predefined” refers to “defined” in a protocol.

In some embodiments of the present disclosure, the “protocol” refers to a standard protocol in the communication field including, for example, the LTE protocol, the NR protocol, and related protocols applied in future communication systems, which is not limited in the present disclosure.

The mentioned term “a plurality of” herein means two or more. The term “and/or” describes the association relationship between the associated objects, and indicates that three relationships may be present. For example, the phrase “A and/or B” means (A), (B), or (A and B). The symbol “/” generally indicates an “or” relationship between the associated objects.

Reference herein to “greater than or equal to” may indicate greater than or equal to or just greater than, and “less than or equal to” may indicate less than or equal to or just less than.

In addition, the step numbers described herein only exemplarily illustrate one possible execution order between steps. In some other embodiments, the steps may not be executed in the order of the numbers. For example, two steps with different numbers are performed simultaneously, or two steps with different numbers are performed in a reverse order to the illustrated sequence, which is not limited in the present disclosure.

Those skilled in the art should understand that in one or more of the above embodiments, the functions described in the embodiments of the present disclosure may be implemented in hardware, software, firmware, or any combination thereof. The functions, when implemented in software, may be stored in a computer-readable medium or transmitted as one or more instructions or codes on a computer-readable medium. The computer-readable medium includes a computer storage medium and a communication medium, where the communication medium includes any medium that facilitates the transfer of a computer program from one place to another. The storage medium is any available medium that is accessible by a general-purpose or special-purpose computer.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Described above are merely exemplary embodiments of the present disclosure and are not intended to limit the present disclosure. Any modifications, equivalent substitutions, improvements, and the like, made within the spirit and principle of the present disclosure should fall within the protection scope of the present disclosure.

1. A method for resource selection, performed by a terminal device, the method comprising:
for N second time-domain units corresponding to a first time-domain unit, performing resource selection based on the N second time-domain units;
wherein the first time-domain unit and each of the N second time-domain units correspond to different carriers, and N is an integer greater than 1.

2. The method according to claim 1, wherein performing resource selection based on the the N second time-domain units comprises:
selecting resources from at least first M second time-domain units of the N second time-domain units in a case where the terminal device selects transmission resources from the N second time-domain units, wherein M is a positive integer less than or equal to N.

3. The method according to claim 2, wherein transmit power corresponding to the transmission resources selected from the N second time-domain units is identical or decreasing.

4. The method according to claim 2, wherein the first time-domain unit satisfies at least one of the following conditions:
the first time-domain unit comprises transmission resources already selected by the terminal device; and
the first time-domain unit comprises transmission resources determined based on sensed first sidelink control information.

5. The method according to claim 4, wherein a signal quality corresponding to the first sidelink control information is greater than a first threshold.

6. The method according to claim 2, wherein selecting the transmission resources from the N second time-domain units comprises:
selecting transmission resources from the N second time-domain units in a case where the terminal device selects transmission resources from a first resource set upon resource exclusion, wherein the first resource set comprises at least one resource on a carrier corresponding to the N second time-domain units.

7. The method according to claim 2, wherein:
a carrier corresponding to the first time-domain unit is a carrier selected by the terminal device within a same frequency band for data transmission or carrier aggregation; and/or
the carrier corresponding to the first time-domain unit has at least one transmission resource already selected by the terminal device.

8. The method according to claim 1, wherein performing the resource selection based on the the N second time-domain units comprises:
avoiding selecting resources from the first time-domain unit in a case where no transmission resources are available in first X second time-domain units of the N second time-domain units, wherein X is a positive integer.

9. The method according to claim 8, wherein avoiding selecting the resources from the first time-domain unit in a case where no transmission resources are available in the first X second time-domain units of the N second time-domain units comprises:
avoiding selecting resources from the first time-domain unit in a case where no transmission resources are available in the first X second time-domain units of the N second time-domain units, and transmission resources are available in the last Y second time-domain units, wherein Y is a positive integer.

10. The method according to claim 8, wherein:
the transmission resources are transmission resources already selected by the terminal device; or
the transmission resources are transmission resources determined by the terminal device based on sensed first sidelink control information.

11. The method according to claim 10, wherein a signal quality corresponding to the first sidelink control information is greater than a second threshold.

12. The method according to claim 8, wherein avoiding selecting the resources from the first time-domain unit comprises:
avoiding selecting resources from the first time-domain unit when selecting transmission resources from a second resource set; or
excluding all candidate resources from the first time-domain unit when performing resource exclusion on the second resource set, and then selecting transmission resources from the second resource set upon resource exclusion;
wherein the second resource set comprises at least one resource on a carrier corresponding to the first time-domain unit.

13. The method according to claim 8, wherein:
a carrier corresponding to the N second time-domain units is a carrier selected by the terminal device within a same frequency band for data transmission or carrier aggregation; and/or
the carrier corresponding to the N second time-domain units has at least one transmission resource already selected by the terminal device.

14. The method according to claim 1, wherein a subcarrier spacing for the carrier corresponding to the first time-domain unit is less than a subcarrier spacing for the carrier corresponding to the N second time-domain units.

15. The method according to claim 1, wherein the carrier corresponding to the first time-domain unit and the carrier corresponding to the N second time-domain units are located in a same frequency band.

16. A terminal device, comprising:
a processor and a memory configured to store one or more computer programs, which when executed by the processor, causes the terminal device to:
for N second time-domain units corresponding to a first time-domain unit, perform resource selection based on the N second time-domain units;
wherein the first time-domain unit and each of the N second time-domain units correspond to different carriers, and N is an integer greater than 1.

17. The terminal device according to claim 16, wherein the one or more computer programs, which when executed by the processor, further causes the terminal device to:
select resources from at least first M second time-domain units of the N second time-domain units in a case where the terminal device selects transmission resources from the N second time-domain units, wherein M is a positive integer less than or equal to N.

18. The terminal device according to claim 17, wherein transmit power corresponding to the transmission resources selected from the N second time-domain units is identical or decreasing.

19. The terminal device according to claim 17, wherein the first time-domain unit satisfies at least one of the following conditions:
the first time-domain unit comprises transmission resources already selected by the terminal device; and
the first time-domain unit comprises transmission resources determined based on sensed first sidelink control information.

20. The terminal device according to claim 19, wherein a signal quality corresponding to the first sidelink control information is greater than a first threshold.
